(19) United States
(12) Patent Application Publication
(10) Pub. No.: US 2020/0065843 A1
(43) Pub. Date: Feb. 27, 2020

(54) System and Method for Managing a Reward-Based Campaign

(71) Applicant: Robust Promotions LLC, Villa Park, IL (US)

(72) Inventor: Gregory P. Seei, Villa Park, IL (US)

(21) Appl. No.: 16/551,182

(22) Filed: Aug. 26, 2019

Related U.S. Application Data
(60) Provisional application No. 62/722,961, filed on Aug. 26, 2018.

(51) Int. Cl. G06Q 30/02

(52) U.S. Cl. CPC G06Q 30/0212; G06Q 30/0257; G06Q 30/0236

(57) ABSTRACT

A computer-implemented system and method for managing a reward-based campaign are disclosed in which an entry code generator operating on one or more processors automatically generates a first set of entry codes and a second set of entry codes. A consumer entry validator operating the one or more processors receives and stores in a consumer database a first consumer entry code and a second consumer entry code, wherein the first consumer entry code is one of the first set of entry codes and the second entry code is one of the second set of entry codes. A winning entry selector operating on the one or more processors develops a winning entry code. A consumer notifier develops a consumer entry from the first consumer entry code and the second consumer entry code and determines that the consumer entry matches winning entry and, in response, instructs a consumer device to display an indication of such match.

### CROSS REFERENCE TO RELATED APPLICATIONS

The present application claims benefit of U.S. Provisional Patent Application Ser. No. 62/722,961, entitled “System and Method of Utilizing Two Alphanumeric Codes to Create Direct Response and/or Cross Promotional, Reward-Based Marketing Campaigns,” filed on Aug. 26, 2018. The entire contents of this application are incorporated herein by reference.

### FIELD OF DISCLOSURE

The present subject matter relates to systems and methods for managing marketing campaigns, and more particularly, to a system and method for managing a reward-based marketing campaign.

### BACKGROUND

A sweepstake is a type of contest where a prize or prizes may be awarded to a winner or winners, where the winning of such prize is largely attributed to luck rather than skill. Typically, sweepstakes are used as marketing promotions to reward existing consumers and to draw attention of consumers to products and/or services. Online sweepstakes may be used to identify new customers and reconnect with the existing customers. Sweepstakes may be quick to set-up, affordable to run, provide an excellent return-on-investment, and are popular with consumers. Some surveys have shown that 7 out of 10 people have played an online game such as a sweepstake, and that 30% of sweepstake or contest participants sign-up to receive information about new products and services.

U.S. Patent Application No. 20060253324A1, filed by James Miller discloses a system and a method for combining subscription services, rewards programs, and sweepstakes. Said method provides a response to a request by a subscriber for a subscription to a product or service, wherein the subscription has a subscription period and wherein the subscription period is initially for a first period of time, automatically providing the subscriber with the product or service for the first period of time, and entering the subscriber into one or more sweepstakes drawings which occur during the first period of time. The method also includes, at the end of the subscription period, automatically renewing the subscription for a next period of time; and in connection with the renewed subscription, automatically entering the subscriber into one or more sweepstakes drawings which occur during the next period of time.

U.S. Pat. No. 6,061,660A, filed by York Eggleston and Andrey Ukhov, discloses a system and a method for incentive programs and award fulfillment; wherein said system provides incentive programs over a computer network in which a host provides sponsoring companies with the capability to buy prepackaged or self-built incentive programs, offer such incentive programs to consumers, provide sponsoring companies and retailers with the capability to associate prizes with incentive programs, provide sponsoring companies, retailers and consumers with convenient fulfillment of prizes, and store and manipulate databases regarding all of the foregoing.

U.S. Patent Application No. 20010032115A1, filed by Michael Goldstein, discloses system and methods for internet commerce and communication based on customer interaction and preferences; wherein said system allows the creation of a custom Internet browsing experience based on consumer preferences; and allows tracking of consumer survey results, consumer spending habits and brand preferences to allow highly targeted marketing.

U.S. Patent Application No. 20020026348A1, filed by Malcolm Fowler, Robert Tucker, and Michael Lukas, discloses a real-time, automated marketing programs implementing one or more program rules matrix modules that calculate benefits to customers based on one or more customer identifier(s), one or more merchant identifier(s) and one or more customer behavior(s). In one embodiment, program rules matrix modules implement Points Multiplier Program(s) that award benefits in an accelerated fashion, based upon one or more qualifying customer identifier(s), merchant identifier(s), and customer behavior(s). Marketing programs are implemented using a host controller that communicates with a plurality of remote transaction systems to provide real-time, individualized, automated awards and sophisticated multi-variable analysis of transaction data. Another aspect of the present invention relates to systems and methods implementing a plurality of marketing programs, offered by a plurality of merchants or merchant groups, upon presentation of a qualifying identifier, such as a transaction card.

U.S. Patent Application No. 20020169660A1, filed by Jason Taylor and Christopher Jackson, discloses a fully integrated online promotion program for goods and/or service providers doing business online and/or offline; wherein said program incorporates a software in which a program participant acquires a quantity of promotion program points, reviews an upcoming real world event, reviews a select set of possible outcomes for the event, and selects one of the possible outcomes as a prediction entry. If the prediction entry is a winning prediction entry, the promotion program administrator distributes a reward to the program participant for making a winning prediction entry during participation in said promotion program.

U.S. Pat. No. 6,656,050B2, filed by Steven Busch and Scott Bolton, discloses a method and apparatus for effectuating sponsor and player driven winning of multiple types of sweepstakes type promotions, contests and games through the unique use of automated game entry, enhanced sharing and trading of game pieces and of an Odds Accelerator that creates variable odds. The present invention provides the unique ability to add real-time variable odds changes to any given sweepstakes or promotion type game involving elements of chance or skill based on pre-determined sponsor rules. The system creates the ability for the players of a given promotion to join together via the system and increase all players' odds of winning a given prize or prizes. The system receives and stores data on its members including the number of elements played, the number of winning elements distributed, the number of losing elements distributed, and any other information required pursuant to set sponsor rules so as to determine the variable nature of a particular game's odds.

U.S. Patent Application No. 20050021399A1, filed by Richard Postrel, discloses a loyalty or reward point system that utilizes the pre-existing infrastructure of a typical credit card network. When a user makes a purchase at a merchant of a product using a credit card, the user is awarded loyalty points from the merchant based on the amount of the purchase. The applicable reward account is maintained on the central server and the number of reward points in the user's account for that merchant is increased accordingly.

U.S. Patent Application No. 20080274794A1, filed by Douglas Mathieson, discloses a computerized method and system for providing an incentive for participating in an activity, comprising: establishing an account with the user; tracking usage of the account made by the user during a period of time, the usage associated with a numerical and/or character string; and transforming the numerical and/or character string into at least two entries for a sweepstakes.

U.S. Pat. No. 5,898,153A, filed by Thomas Lagan and Charlie Sims, discloses a system/method for automatically processing sweepstakes entries and mail orders; wherein said system reads a machine code identifying the sender and simultaneously detects orders from non-orders using a magnetic field detector, without opening the envelopes, identifies the contestant's code and enters him or her into the sweepstakes. During the outgoing mail processing, the code may be preprinted on each carrier envelope or reply insert. The code may be read and used to print a machine code corresponding thereto on the return envelope.

U.S. Patent Application No. 20060047573A1, filed by Robert Mitchell, Charles

Brown and Thomas Cetta, discloses a coupon and sweepstakes dispensing system and method. The system includes coupon providing a free sweepstakes entry. The coupon includes a redemption value N-times the purchase price. The free sweepstakes entry provides a chance to win items with redemption values M-time purchase price of the coupons. Shoppers select to purchase coupons for a nominal fee for the time saved, convenience, value and variety, plus automatically, are entered into a free sweepstakes that can bring cash or credit at the retail establishment where they are shopping.

U.S. Pat. No. 6,173,267B1, filed by Laurie Cairns, discloses a method and a system for providing fulfillment in a promotional contest; wherein said system provides a card in a product package marked with an internet address and a password, allowing the purchaser of the product to contact the internet address and input personal information, including the password in order to learn if he/she is a winner in the contest. If the purchaser is a winner, the card is sent to the company to verify the winning status before sending the prize to the purchaser.

U.S. Pat. No. 8,366,544B2, filed by Geoffrey Gelman, James Jorasch, Peter Kim and Timothy Palmer, discloses a method and apparatus for conducting a promotion and for distributing promotions to potential users; said system provides merchants or promotion organizers flexibility in the way they conduct the promotion as well as an ability to change one or more aspects of the promotion during the operation of the promotion. In accordance with one embodiment, such a promotion may provide for a game on a mobile device, wherein a locked outcome of the game may be unlocked using an unlock code. In one embodiment, a result of the locked outcome may correspond to an intra-game benefit.

U.S. Patent Application No. 20060069619A1, filed by Jay Walker, Magdalena Fincham, Stephen Tulley, and Daniel Tedesco, discloses systems and methods for facilitating group rewards; wherein articles of manufacture may determine a rewards group comprising at least a first member and a second member, determine a reward that the group may earn in exchange for completing purchases at a retailer or for performing a task. Further embodiments may focus on a count of group members and a value of the reward, purchasing or task completion conditions the group must satisfy in order to earn the reward. The groups may be labeled to attach specific conditions, determining an acceptance of the conditions by the group, and registering the group for the reward. According to some embodiments, the reward may be provided to the group (or portions thereof) upon a determination that the conditions are satisfied (or at least partially satisfied).

U.S. Patent Application No. 20070155468A1, filed by Mark Olmstead and Johnney Weaver, discloses a personal identification card for use in a sweepstakes network is capable of being purchased for goods and services unrelated to a sweepstakes. The personal identification card includes a personal identification number associated with the personal identification card and readable and writeable digital storage means for storing digital data related to the sweepstakes and the goods and services unrelated to the sweepstakes.

### SUMMARY

According to one aspect, a computer-implemented reward-based campaign management system includes an entry code generator operating on one or more processors that automatically generates a first set of entry codes and a second set of entry codes, a consumer entry validator operating on the one or more processors that receives and stores in a consumer database a first consumer entry code and a second consumer entry code, wherein the first consumer entry code is identical to one of the first set of entry codes and the second consumer entry code is identical to one of the second set of entry codes, and a winning entry selector operating on the one or more processors that develops a winning entry. The reward-based campaign management system further includes a consumer notifier that develops a consumer entry from the first consumer entry code and the second consumer entry code and determines that the consumer entry matches the winning entry and, in response, instructs a consumer device to display an indication of such match.

According to another aspect, a method of conducting a computer-implemented reward-based campaign management system includes the step of causing one or more processors to undertake automatically generating a first set of entry codes and a second set of entry codes, receiving and storing in a consumer database a first consumer entry code and a second consumer entry code, and developing a winning entry. The first consumer entry code is identical to one of the first set of entry codes and the second consumer entry code is identical to one of the second set of entry codes. The method further includes causing the one or more processors to undertake automatically developing a consumer entry from the first consumer entry code and the second consumer entry code, automatically determining that the winning entry and the consumer entry match and, in response, instructing a consumer device to display an indication of such match.

Other aspects and advantages will become apparent upon consideration of the following detailed description and the attached drawings wherein like numerals designate like structures throughout the specification.

### BRIEF DESCRIPTION OF THE DRAWINGS

FIG. 1 is a system diagram of a reward-based campaign management system;

FIG. 2 is another system diagram of the reward-based campaign management system of FIG. 1;

FIG. 3 is a flowchart that shows the steps undertaken by the reward-based campaign management to generate and distribute entry codes;

FIG. 4 is a flowchart that shows the steps undertaken by the reward-based campaign management system to interact with a consumer device; and

FIG. 5 is a flowchart that shows the steps undertaken by the reward-based campaign management system to receive information from a participating business system.

### DETAILED DESCRIPTION

A sweepstakes contest is operated periodically (e.g., once a week, once a month, and the like) in which an entry associated with the sweepstake is selected to win a predetermined reward, such as money, a discount, a product, a service, and the like. The reward is presented to a consumer, if any, who is associated with the selected entry. As described herein, the consumer obtains a fractional portion of an entry, an entire entry, or a plurality of entries upon completion of predetermined activities at one or more participating businesses such as vendors and service providers.

In some embodiments, at the end of the period during which the sweepstake is operated, an entry is randomly selected from entries provided to consumers and the consumer with the selected entry is awarded the prize. In other embodiments, the entry is randomly selected from a pool of predetermined entries, and if a consumer is associated with such randomly selected entry then the such consumer is awarded the prize.

If a consumer receives a fractional entry from an activity, the consumer may need to undertake one or more additional activities to obtain additional fractional entries such that combination of all such the fractional entries form a complete entry. In some embodiments, each fractional entry is a code (e.g., a sequence of alphanumeric characters) and two or more fraction entry may be combined in a predetermined order to form an entry.

For example, the consumer may receive a first fractional portion of an entry (e.g., an alphanumeric sequence “ABCDEF”) by purchasing gasoline at a participating gas station and receive a second fractional portion of the entry (e.g., the alphanumeric sequence “123456”) by purchasing a qualified product (e.g., a refreshment, car maintenance product, etc.) from a store associated with the participating gas station. The combination of the first and second fractional portions may be sufficient to provide the consumer one entry for a sweepstakes during a particular period. In the foregoing example, the entry may have an identifier associated therewith that is the series of alphanumeric characters that results when first and second fractional portions of the entry are concatenated (i.e., “ABCDEF123456”). If the combination of entry codes acquired by the consumer matches the identifier of a selected winning entry, then then consumer is awarded a prize associated with the sweepstake. In some embodiments, a winning entry identifier is selected, and entry codes of fractional portions held by each consumer are combined to form a consumer entry identifier. The consumer entry identifier is compared to the winning entry identifier to determine if the two match (e.g., they are identical identifiers) and, if so, the consumer is awarded a prize.

In other embodiments, the winning entry identifier is separated into fractional portions of the winning entry (each portion having a winning entry code associated therewith), and a consumer having factional portions that have entry codes that match the entry codes of all of fractional winning portions is awarded the prize. Other ways of identifying a consumer who has fractional portions that when combined match a winning entry identifier apparent to one who has ordinary skill in the art may be used. Although this example describes creating an entry from two fractional portions, it should be apparent that any number of fractional portions may be combined to form entry. Further, it should be apparent to one of ordinary skill in the art that entry codes may be combined in ways other than concatenation to form a complete entry.

The consumer may be provided with an electronic tool (e.g., a web site, a computer application, a smartphone application, and the like) to allow the consumer to enter codes associated with whole or fractional portions of entries, monitor entries acquired thereby, be notified of opportunities to obtain additional entries, be notified of having a winning entry, and the like.

Similarly, the participating businesses may be provided with tools with which to obtain and/or generate entry identifiers or codes associated with fractional portions of entries to distribute to consumers.

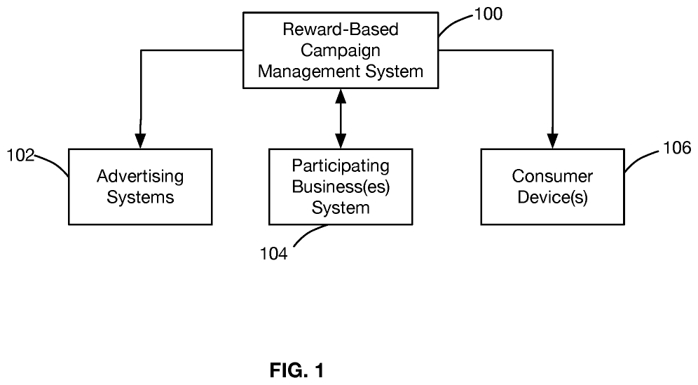

Referring to FIG. 1, a reward-based campaign management system 100 generates entry codes associated and distributes such entry codes to consumers and participating businesses. The following disclosure refers to an entry code being provided to a participating business or consumer. However, it should be apparent to one who has ordinary skill in the art that such entry code may be a code associated with a fractional portion of an entry or a combination of entry codes of a sufficient quantity of fractional portions to form a whole entry, as described above.

The reward-based campaign management system 100 may provide to an advertising system 102 a first set of entry codes for distribution directly to consumers. An operator of the advertising system 102 may distribute such entry codes via advertising (e.g., television, radio, printed, online, display, billboard, and the like), direct mail sent to the consumer, handouts, flyers, and the like.

The reward-based campaign management system 100 may distribute a second set of entry codes to participating businesses or a system 104 operated thereby. Such system 104 may be, for example, a point-of-sale system used by the participating business or a marketing system associated with the participating business. Each entry of the second set distributed to the participating business system 104 may be associated with one or more particular action(s), and such entry is provided to a consumer of the participating business upon execution of such particular action(s). For example, if the participating business is a gasoline station, some of the entry codes that comprise the second set may be associated with an action of purchasing at least a particular quantity of gasoline. The participating business may then provide one such entry code consumers who purchase such quantity of gasoline. Other entry codes of the second set may be associated with an action of purchasing a food product from the particular business within a particular time period before or after the purchase of the gasoline, and such other code may be provided to the consumer who purchases the particular quantity of gasoline and the food product within the particular duration of time.

The reward-based campaign management system 100 also communicates with devices 106 operated by consumers. As described above, the reward-based campaign management system 100 may instruct such devices to allow the consumer to submit to the reward-based campaign management system 100 entry codes acquired thereby, display information regarding entry codes acquired by the consumer, be notified of opportunities to obtain additional entry codes, be notified of having a winning entry, and the like.

Further, in some embodiments, the participating business systems 104 electronically notifies the reward-based campaign management system 100 that a particular consumer has undertaken an action and has qualified to receive an entry code. In response, the reward-based campaign management system 100 stores such information in a database record associated with the consumer and allows the consumer to use the consumer device 106 operated thereby to confirm that such entry code for the fraction portion of the entry has been correctly stored. In this manner, the reward-based campaign management system 100 frees the participating business from having to distribute codes directly to a consumer via physical media such as, for example, a receipt or a paper ticket, and also frees the consumer from having to manage such physical media. Also, automatic notification by the participating business system 104 to the reward-based campaign management system 100 that an entry identifier or a code for a fractional portion of an entry has been provided to the consumer further frees the consumer from having to enter such identifier or code.

The communications between the reward-based campaign management system 100 and the advertising systems 102, participating business system 104, and the consumer devices 106 may be undertaken over a network, for example, the Internet, a virtual private network, a local network, and the like. Further, the reward-based campaign management system 100 may push information to one or more of the advertising systems 102, participating business system 104, and/or consumer devices 106. For example, prior to each sweepstakes period, the reward-based campaign management system 100 may transmit to one or more of the advertising system(s) 102 and the participating business system(s) 104 entry codes (and any action information associated with such entry codes) that are to be distributed thereby during the sweepstakes period. In some cases, one or more of the advertising system(s) 102 and the participating business system(s) 104 may electronically retrieve such entry codes and action information from the rewards based campaign management system 100 by, for example, downloading such information, remotely querying a database comprising the rewards based campaign management system 100 for such information, or any other data exchange method apparent to one who has ordinary skill in the art.

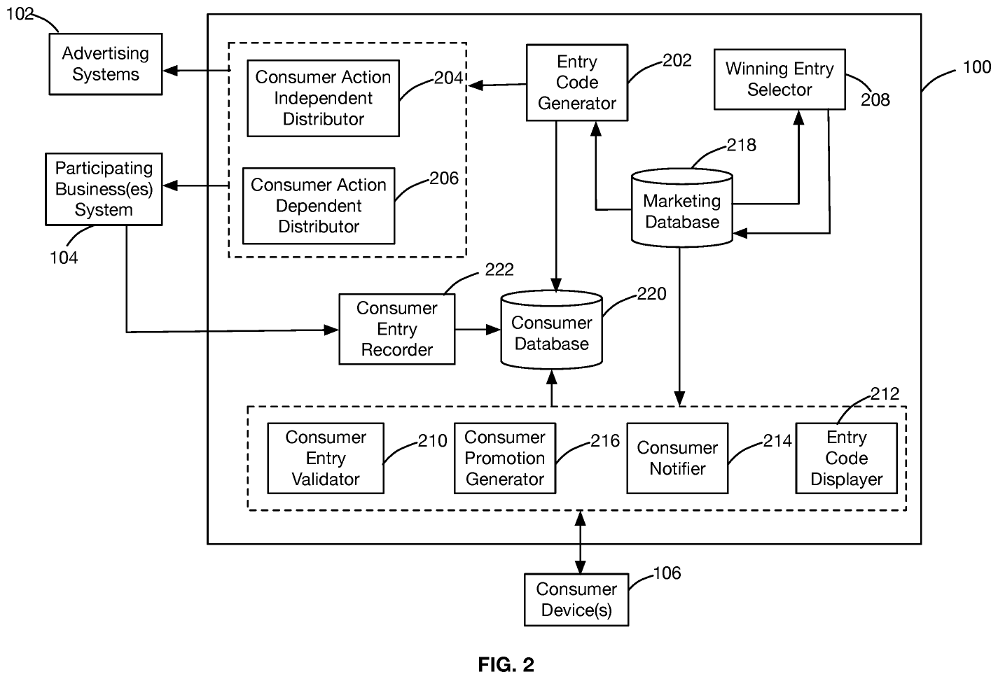

Referring to FIG. 2, in one embodiment the reward-based campaign management system 100 includes an entry code generator 202, a consumer action independent distributor 204, a consumer action dependent distributor 206, a winning entry selector 208, a consumer entry validator 210, an entry code displayer 212, a consumer notifier 214, a consumer promotion generator 216, and a consumer entry recorder 222. The reward-based campaign management system 100 also includes a consumer database 220 and a marketing database 218.

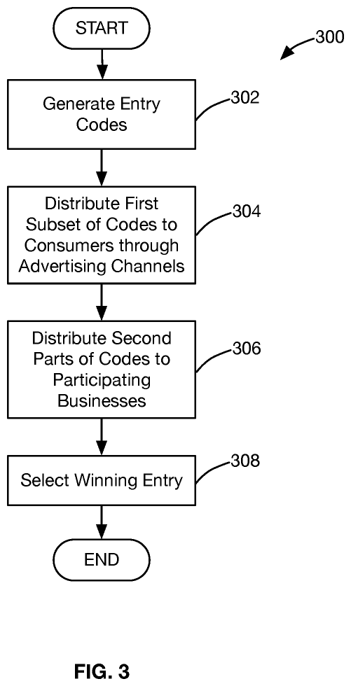

FIG. 3 shows a flowchart 300 of processing undertaken by the reward-based campaign management system 100 to generate entry codes and to select a winning entry for a sweepstakes. Referring to FIGS. 2 and 3, at step 302, the entry code generator 202 generates a plurality of entry codes for fractional portions associates a consumer action (if any) with such entry codes. For example, a first range of entry codes (e.g., “ABCDEF” and “GHIJKL”) may be not be associated with any actions, a second range of entry codes (e.g., entry codes between “001000” and “009999”) may be associated with a first action (e.g., purchase of at least a particular quantity of gasoline), and a third range of entry codes (e.g., entry codes between “010000” and “999999”) may be associated with a third action (e.g., purchase of food within a particular time period of purchasing gasoline).

The entry code generator 302 generates the entry codes and actions associated therewith in accordance with rules stored in a marketing database 218. Such rules may specify the number of entry codes to generate, the types of actions to be associated with entry codes, and the alphanumeric ranges to associate with such actions, and the alphanumeric ranges to associate with entry codes that do not require the recipient to undertake any action, and the like. In addition, the marketing database 218 specifies ranges of entry codes to be distributed via particular advertising system(s) 102 (FIG. 1) and via particular participating business system(s) 104.

The rules in the marketing database 218 may also specify the number of fractional entry codes that must be combined to form a complete entry identifier and the order in which such fractional entry codes must be combined. For example, the marketing database 218 may specify that an identifier of a complete entry may be formed by concatenating in order one of the two entry codes in the first set with an entry code in either the second set or the third set. Thus, a valid entry code may have values in the range “ABCDEF01000” through “ABCDEF999999” and “GHIJKL01000” through “GHIJKL999999.”

In some embodiments, the entry code generator 202 may generate a set of entry code identifiers, and then separate each entry code identifier into a first entry code representing a first fractional portion and a second entry code representing a second fractional portion to create a first set of entry codes and a second set of entry codes, respectively. Further, as noted above, each entry identifier may be separated into more than two fractional portions, each fraction portion associated with an entry code.

After the entry codes are generated, at step 304, the consumer action independent distributor 204 transmits those entry codes that do not require any consumer action to the advertising system(s) 102 and/or participating business system(s) 104 that are to distribute such codes to consumers. Similarly, at step 306, the consumer action dependent distributor 206 transmits those entry codes that require an action by a consumer to receive the entry code and information regarding such action to the advertising system(s) 102 and/or participating business system(s) 104 that are to distribute such codes.

In some embodiments, after the entry codes have been generated and distributed, the winning entry selector 208 randomly selects, at step 308, from the generated entry codes, a combination of entry codes in accordance with the number of fractional entry codes required and the order in which such fractional entry must be combined to form a winning entry, as specified by the marketing database 218 and described above. In other embodiments, the reward-based campaign management system 100 undertakes step 308 to select the winning combination of entry codes immediately after the entry codes have been generated by the entry code generator 202 at step 302 or after expiration of the period of time during which the sweepstakes is run. In some embodiments, the winning entry selector 208 selects a combination of entry codes to form the winning entry only from those codes actually distributed to consumers as recorded in the consumer database 220 (described below). In some embodiments, the winning entry selector 208 records the combination of entry codes that form the winning entry in the marketing database 218.

In some embodiments, the winning entry selector 208 randomly selects a winning entry identifier. In other embodiments, the winning entry identifier (or winning entry codes of fractional portions) may be selected externally from the reward-based campaign management system and transmitted by an external system (not shown) to the winning entry selector 208 for recording in the marketing database 218.

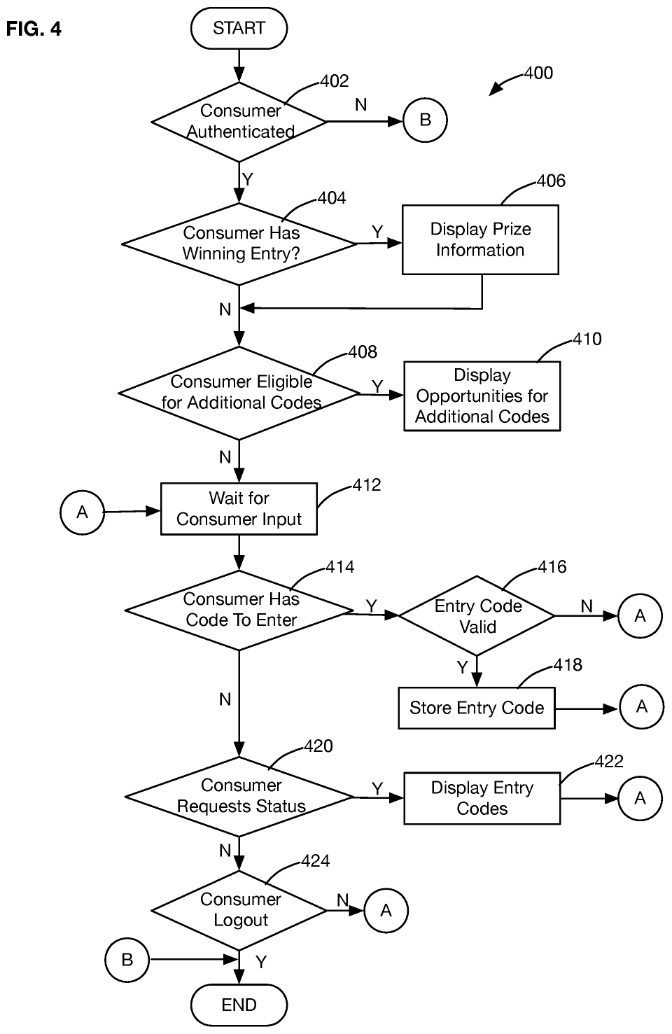

FIG. 4 shows a flowchart 400 of the steps undertaken by the reward-based campaign management system 100 to communicate with a particular consumer device 106.

Referring to FIGS. 2 and 4, when a consumer device 106 requests access to the reward-based campaign management system 100, at step 402, the reward-based campaign management system 100 may instruct the device 106 to transmit thereto credentials associated with the consumer. Such credentials may be, for example, a username and password that has previously been registered by the consumer with the reward-based campaign management system 100 and stored in a consumer database 220. At step 402, if the credentials transmitted by the device 106 match those stored in the consumer database 220, then the reward-based campaign management system 100 proceeds to step 404. Otherwise, the reward-based campaign management system 100 displays an error message and terminates communication with the consumer device 106.

As is described in greater detail below, for each sweepstakes period, the consumer database 220 includes data for the consumer associated with validated credentials that includes a record of all of the entries and fractional entries acquired by the consumer during such sweepstakes period. At step 404, a consumer notifier 214 compares the combination of winning entry codes of a completed sweepstake (i.e., a sweepstakes having a time period that has expired) with combinations of the entries of the consumer acquired during the period of the completed sweepstake and stored in the consumer database 220. If the consumer notifier 212 finds a combination of entry codes acquired by the consumer that matches the combination of winning entry codes (e.g., each entry code acquired by the consumer is identical to a corresponding winning entry code), the consumer notifier 212 proceeds to step 406, otherwise the reward-based campaign manager 100 proceeds to step 408.

In some embodiments, as step 404, the consumer notifier may combine entry codes acquired by the consumer as described above to develop consumer entry identifiers (i.e., consumer entries) and compare such consumer entry identifiers with the winning entry identifier stored in the marketing database 218 (as described above). If one such consumer entry identifier matches (e.g., is identical to) the winning entry, the consumer notifier 214 proceeds to step 406. If no such consumer entry identifier matches the winning entry, the reward-based campaign manager 100 proceeds to step 408.

At step 406, the consumer notifier 212 instructs the consumer device 106 to display a message that the consumer has won a sweepstakes and information regarding how to claim the prize associated with such sweepstakes. In some embodiments, the prize may be credited to a credit card or bank account associated with the consumer and stored in the consumer database 220. In other embodiments, the reward-based campaign management system 100 may generate and transmit instructions to one of the advertising systems 102 or a participating business system 104 to generate a prize such as a coupon, gift card, or a check and send the prize to a mailing address associated with the consumer. As would be understood by one who has ordinary skill in the art, such credit card, bank account, and/or mailing address information is acquired when the consumer initially creates the credentials to access the reward-based campaign management system 100.

At step 408, the consumer promotion generator 216 determines if the consumer associated with the consumer device 106 is eligible to acquire additional entry codes. For example, the consumer promotion generator 216 analyzes the entry codes acquired by the consumer in connection with the currently active sweepstakes and the marketing rules in the marketing database 218 to determine if the consumer would be eligible to receive an additional entry code if the consumer were to undertake an additional action. For example, if the consumer has purchased gasoline and has received an entry code as a result of such purchase and the marketing database indicates that a consumer who has purchased gasoline would be eligible to receive an additional entry by purchasing wiper blades, the consumer promotion generator 216 may instruct the consumer device 106 at step 410 to display a message that the consumer would receive an additional entry code upon purchase of a wiper blade. After the consumer promotion generator 216 has instructed the consumer device 106 to display one or more such opportunities, the reward-based campaign management system 100 proceeds to step 412 and waits to receive from the consumer device 106 an indication of an input by the consumer using such device 106. Such indication may result from touching or clicking on a region of a display of the device 106, selection of a button, a menu-item, and the like.

At step 414, the reward-based campaign management system 100 determines if the input received at step 412 is associated with an indication that the consumer has an entry to enter and store in the reward-based campaign management system 100.

If so, at step 416, a consumer entry validator 208 instructs the consumer device 106 to prompt the operator to enter such entry code and transmit the entry code to the reward-based campaign system 100. The consumer entry validator 208 receives, also at step 416, such entry code and compares the entry code with the entry codes generated for the sweepstakes currently being run to confirm the validity of the entry code. At step 418, if the entry code is valid then the consumer entry validator 208 stores the entry code in the data associated with the consumer in the consumer database 220. Thereafter, the reward-based campaign management system 100 returns to step 412 to wait for another input.

If the entry code is determined to not be valid at step 416, the consumer entry validator 208 instructs the consumer device 106 to display an error message and the reward-based campaign management system 100 returns to step 412 to wait for another input.

In some embodiments, the consumer entry validator 208, as step 416, may instruct the consumer device 106 to request and transmit additional information such as when the entry code was acquired, how the consumer acquired the entry code, and the like and compares such additional information with information stored in the marketing database 218 to confirm the validity of the entry code.

If at step 414, the input received at step 412 does not indicate that the consumer has an entry code to enter, the rewards-based campaign management system 100 determines, at step 420, if the input indicates that the operator of the device 106 wishes to view the entry codes acquired thereby and recorded in the consumer database 220. If so, at step 422, an entry code displayer 212 queries the consumer database 220 to retrieve entry codes stored therein and associated with the consumer, transmits information regarding such entry codes to the consumer device 106, and instructs the consumer device 106 to display such information. In some embodiments, the entry code displayer 212 displays entry codes recorded in connection with the currently active sweepstakes. In other embodiments, the entry code displayer 212 also displays entry codes from completed sweepstakes. If entry codes from multiple sweepstakes are displayed, dates when the sweepstakes associated with the entry codes were run may also be displayed. Thereafter, the reward-based campaign management system 100 proceeds to step 412 to wait for another input.

If, at step 420, the reward-based campaign management system 100 determines the input received at step 412 is not associated with a request to display of entry codes acquired by the operator of device 106, the reward-based campaign management 100 determines, at step 424, if the input indicates the consumer wishes to logout and, if so, the reward-based campaign management system 100 disconnects from the consumer device 106. Otherwise, the reward-based campaign management system 100 proceeds to step 412 to wait for another input.

It should be apparent to one who has ordinary skill in the art that the steps shown in the flowchart 400 may generate a web browser page or one or more windows of an application program operating on the device 106, and that the requests by the consumer operating such device 106 may be invoked by selecting menu items, buttons, and the like using an input device such as a mouse, a keyboard, a touchscreen, and the like. Further, in some embodiments, the device 106 may be automatically instructed to display whether the consumer has won a prize (step 404), has opportunities for additional codes (step 408), and recently recorded entry codes (step 422) after the operator has been authenticated at step 402, without requiring the operator to actively request such information.

Further, it should be apparent to one who has ordinary skill in the art, that the reward-based campaign management system 100 may use notification protocols, instant messaging protocols, and/or SMS protocols instruct the device 106 to automatically display a message when the consumer associated with such device 106 has won a prize or is eligible for an additional opportunity to obtain additional entry codes, without the consumer having to load a browser page or open an application on such device 106.

The campaign management system 100 may be integrated with an application or web page associated with a participating business. For example, if such participating business application is used to display a map or listing of business locations, such map or listing of business locations may include an indication (e.g., an icon or other indicia) that one or more entry codes may be acquired at certain locations by undertaking particular actions. Thus, providing the participating business a way to drive consumers to undertake particular actions at particular business locations.

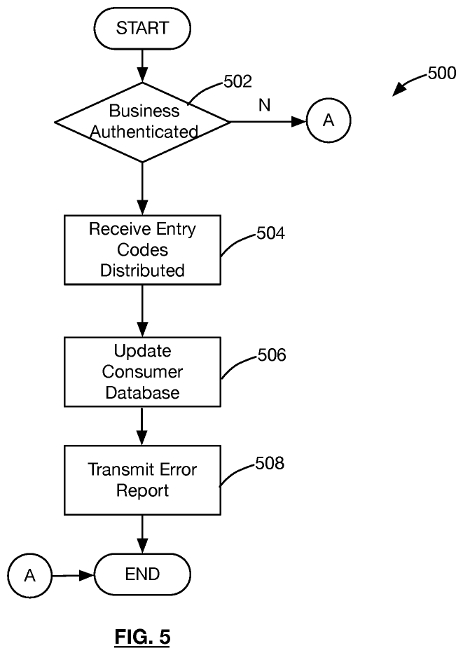

In some embodiments, a point-of-sale system component of the participating business system 104 may automatically upload information regarding entry codes distributed by the participating business associated with such system 104. Such information may include the entry code distributed, identifying information about the consumer who received the entry code, the date the entry code was provided to the consumer, the transaction that resulted in the entry code being provided to the consumer, and the like. FIG. 5 is a flowchart 500 of the operation of steps undertaken by the reward-based campaign management system 100 to receive such information.

Referring to FIGS. 2 and 5, at step 502 the reward-based campaign management system 100 receives a request to upload entry code information from a participating business system 104. Such request includes credential information to ensure that the participating business system 104 is authorized to communicate with the reward-based campaign management system 100. Also, at step 502, the credential information is authenticated by comparing such information to credentials previously registered with the participating business system 104 and stored, for example, in the marketing database 218. If such authentication is successful, the reward-based campaign management system 100 proceeds to step 504, otherwise, the reward-based campaign management system 100 terminates communications with the participating business system 104.

At step 504, a consumer entry recorder 222 of the reward-based campaign management system 100 receives a transmission of the information regarding distributed entry codes described above. At step 506, the consumer entry recorder 222 validates the information received at step 504. Such validation may include, for example, making sure each entry code that was distributed was provided to the participating business system 104, making sure the alphanumeric characters associated with the distributed entry code are in the range of entry codes that were eligible for distribution during a particular period of time (e.g., are associated with a sweepstakes operating during such period of time), that the consumer to whom the entry code was provided is registered with the reward-based campaign management system 100, and the like.

Also, at step 504, the consumer entry recorder 222 updates the consumer records in the consumer database 220 for each entry code successfully validated thereby. At step 508, the consumer entry recorder 222 generates and transmits to the participating business system 104 information regarding entry codes that were not validated successfully. Thereafter, the reward-based campaign management system 100 terminates communications with the participating business system 104.

It should be apparent that the reward-based campaign management system 100 may be used to generate and provide entry codes to consumers in exchange for particular behaviors.

For example, a consumer may receive a first entry code for purchasing an airline ticket on a particular airline to a particular destination. The consumer may receive a second entry code for staying at a particular hotel at particular destination. As described above, the first and second entry codes combine to form an entry in a sweepstakes. The consumer may be provided with additional entry codes to generate additional entries in the sweepstakes by eating at a particular restaurant in the particular destination. For example, the consumer may receive sufficient entry codes to have a predetermined number of additional entries in the sweepstakes. In some embodiments, the predetermined number of additional entries is calculated by multiplying a number of entries the consumer has acquired by performing one or more particular actions by a predetermined multiplier. As disclosed above, the reward-based campaign management system 100 would inform the consumer of such opportunities to obtain entry codes and/or complete entries in exchange for particular actions and track the entry codes and/or entries acquired by the consumer.

In some embodiments, a participating business (e.g., an airline, a store, a credit card, and the like) may provide the consumer with an opportunity to exchange a predetermined number loyalty or affinity points the consumer has acquired with the participating business for an entry code. The participating business may transmit information regarding entry codes provided in this manner to the reward-based campaign management system 100 as described above.

In some embodiments, a first entry code provided to a consumer may be predetermined based on a first sequence of alphanumeric characters associated with the consumer (e.g., residential zip code associated with the consumer, a phone number area code or prefix, a portion of a loyalty account number, and the like). A second entry code may be a randomly generated entry code. In this manner, the sweepstakes may be undertaken in particular regions or for consumers who have a loyalty account number associated with a participating business.

In some embodiments, a plurality of consumers may be provided a first entry code having an identical sequence of alphanumeric characters. Each consumer may be provided with a second entry code that has an alphanumeric sequence generated in accordance with demographic or behavioral information (e.g., profession, residence, income, purchase history, etc.) associated with the consumer.

In some embodiments, a first entry code may be valid for a plurality of sweepstakes, a second entry code may be valid only for a first one of the plurality of sweepstakes, and a third entry code may be valid only for a second one of the plurality of sweepstakes. Thus, the first entry code may be combined with the second and third entry codes to enable the consumer to enter the first and the second sweepstakes, respectively.

It should be apparent to those who have skill in the art that any combination of hardware and/or software may be used to implement the reward-based campaign management system 100 described herein. It will be understood and appreciated that one or more of the processes, sub-processes, and process steps described in connection with FIGS. 1-5 may be performed by hardware, software, or a combination of hardware and software on one or more electronic or digitally-controlled devices. The software may reside in a software memory (not shown) in a suitable electronic processing component or system such as, for example, one or more of the functional systems, controllers, devices, components, modules, or sub-modules schematically depicted in FIGS. 1-5. The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module or controller (e.g., the entry code generator 202, the consumer action independent distributor 204, the consumer action dependent distributor 206, the winning entry selector 208, the consumer entry validator 210, the entry code displayer 212, the consumer notifier 214, the consumer promotion generator 216, and the consumer entry recorder 222 of FIG. 1), which includes, for example, one or more microprocessors, general purpose processors, combinations of processors, digital signal processors (DSPs), field programmable gate arrays (FPGAs), application-specific integrated circuits (ASICs), and/or graphics processing units (GPUs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

It should be apparent to one who has skill in the art that one or more components of the reward-based campaign management system 100 may operate in a cloud environment, for example, using distributed computing and storage systems connected over a local or wide area network (e.g., the Internet or a private network). For example, the entry code generator 202, the consumer action independent distributor 204, the consumer action dependent distributor 206, the winning entry selector 208, the consumer entry validator 210, the entry code displayer 212, the consumer notifier 214, the consumer promotion generator 216, and the consumer entry recorder 222 may operate on one or more computer(s) remote one another and one or both of the marketing database 218 and the consumer database 220.

The executable instructions may be implemented as a computer program product having instructions stored therein which, when executed by a processing module of an electronic system, direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access, i.e., volatile, memory (electronic); a read-only memory (electronic); an erasable programmable read only memory such as, for example, Flash memory (electronic); a compact disc memory such as, for example, CD-ROM, CD-R, CD-R W (optical); and digital versatile disc memory, i.e., DVD (optical).

It will also be understood that receiving and transmitting of signals or data as used in this document means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only and should not be taken as limiting the scope of the disclosure.

We claim:

1. A computer-implemented reward-based campaign management system comprises:
an entry code generator operating on one or more processors that automatically generates a first set of entry codes and a second set of entry codes;
a consumer entry validator operating on the one or more processors that receives and stores in a consumer database a first consumer entry code and a second consumer entry code, wherein the first consumer entry code is identical to one of the first set of entry codes and the second consumer entry code is identical to one of the second set of entry codes;
a winning entry selector operating on the one or more processors that develops a winning entry; and
a consumer notifier that develops a consumer entry from the first consumer entry code and the second consumer entry code and determines that the consumer entry matches the winning entry and, in response, instructs a consumer device to display an indication of such match.

2. The computer-implemented reward-based campaign management system of claim 1, further comprising a distributor operating on the one or more processors that transmits the first plurality of entry codes to a first system and the second plurality of codes to a second system.

3. The computer-implemented reward-based campaign management system of claim 1, wherein each of the second plurality of entry codes is associated with a particular action, wherein the action is defined by rules in a marketing database.

4. The computer-implemented reward-based campaign management system of claim 1, wherein the consumer entry comprises a first consumer entry and further comprising a consumer promotion generator operating on the one or more processors that automatically determines that a consumer associated with the first and the second consumer entry codes is eligible to acquire one of a third consumer entry code and a second consumer entry upon execution of an action, and the consumer promotion generator automatically instructs the consumer device to display a message regarding such eligibility.

5. The computer-implemented reward-based campaign management system of claim 4, wherein the consumer promotion generator transmits the message to the consumer device using a notification, instant messaging, and/or SMS protocol.

6. The computer-implement reward-based campaign management system of claim 4, wherein the consumer notifier develops a third consumer entry from the third consumer entry code and determines that that one of the second and third consumer entries matches the winning entry and, in response, instructs a consumer device to display an indication of such match.

7. The computer-implemented reward-based campaign management system of claim 1, further comprising an entry code displayer operating on the one or more processors that retrieves from a consumer database entry codes associated with the consumer device and instructs the consumer device to display the retrieved entry codes.

8. The computer-implemented reward-based campaign management system of claim 7, wherein the entry code displayer retrieves the entry codes from the consumer database in response to a request received from the consumer device.

9. The computer-implemented reward-based campaign management system of claim 1, further comprising a consumer entry recorder that receives from a business system, external to the reward-based campaign management system, information regarding an entry code distributed to a consumer.

10. The computer-implemented reward-based campaign management system of claim 9, wherein the consumer entry recorder determines that the consumer is registered with the reward-based campaign management system and in response stores the received information in the consumer database.

11. The computer-implemented reward-based campaign management system of claim 1, wherein the consumer notifier causes the consumer device to display the indication of the match using one of notification, instant messaging, and SMS protocols.

12. A method of managing a computer-implemented reward-based campaign comprising the step of:
causing one or more processors to undertake:
automatically generating a first set of entry codes and a second set of entry codes;
receiving and storing in a consumer database a first consumer entry code and a second consumer entry code, wherein the first consumer entry code is identical to one of the first set of entry codes and the second consumer entry code is identical to one of the second set of entry codes;
selecting a winning entry; and
automatically developing a consumer entry from the first consumer entry code and the second consumer entry code;
determining that the winning entry and the consumer entry match and, in response, instructing a consumer device to display an indication of such match.

13. The method of claim 12, further causing the one or more processors to undertake transmitting the first plurality of entry codes to a first system and the second plurality of codes to a second system.

14. The method of 12, wherein each of the second plurality of entry codes is associated with a particular action, wherein the action is defined by rules in a marketing database.

15. The method claim 12, wherein the consumer entry comprises a first consumer entry, further causing the one or more processors to undertake automatically determining that a consumer associated with the first and the second consumer entry codes is eligible to acquire one of a third consumer entry code and a second consumer entry upon execution of an action, and automatically instructing the consumer device to display a message regarding such eligibility.

16. The method of claim 15, further causing the one or more processors to undertake automatically determining that the winning entry and one of the second and third consumer entries match and, in response, instructing a consumer device to display an indication of such match.

17. The method of claim 13, wherein instructing the consumer device to display the message includes comprises transmitting the message using a notification, instant messaging, and/or SMS protocol.

18. The method of claim 17, further causing the one or more processors to undertake retrieving from a consumer database entry codes associated with the consumer device and instructs the consumer device to display the retrieved entry codes.

19. The method of claim 18, wherein retrieving the entry codes from the consumer database is undertaken in response to receiving a request received from the consumer device.

20. The method of claim 19, further causing the one or more processors to undertake receiving from a business system, external to the one or more processors, information regarding an entry code distributed to a consumer.

21. The method of claim 20, further causing the one or more processors to automatically undertake determining that the consumer is registered with the reward-based campaign management system and in response storing the received information in the consumer database.

22. The method of claim 13, wherein instructing the consumer device to display the indication of the match comprises using one of notification, instant messaging, and SMS protocols.
